(19) United States
(12) Patent Application Publication
(10) Pub. No.: US 2025/0092290 A1
(43) Pub. Date: Mar. 20, 2025

(54) CURABLE COMPOSITION, CURABLE ADHESIVE FILM AND ADHESIVE TAPE

(71) Applicant: 3M INNOVATIVE PROPERTIES COMPANY, St. Paul, MN (US)

(72) Inventors: En Zhong Zhang, Shanghai (CN); Heng Yu Huan, Shanghai (CN); Li Jing Zhang, Shanghai (CN); Pu Ren, Nanchang city (CN); Xin Xin Sun, Shanghai (CN)

(21) Appl. No.: 18/727,546

(22) PCT Filed: Mar. 8, 2023
(86) PCT No.: PCT/IB2023/052202

§ 371 Date: Jul. 9, 2024

(30) Foreign Application Priority Data
Mar. 30, 2022 (CN) 202210327848.X

(51) Int. Cl. C09J 163/00; C08K 5/375; C08K 5/5419; C09J 7/35; C09J 131/04

(52) U.S. Cl. CPC C09J 163/00; C08K 5/375; C08K 5/5419; C09J 7/35; C09J 131/04; C09J 2301/122; C09J 2301/304; C09J 2301/414; C09J 2301/416; C09J 2400/22; C09J 2459/00

(57) ABSTRACT

The present invention provides a curable composition, a curable adhesive film, and an adhesive tape. Specifically, the curable composition comprises, based on the total weight thereof as 100 wt %: 15-50 wt % of an ethylene-vinyl acetate copolymer; 10-40 wt % of polyvinyl butyral; and 20-60 wt % of an epoxy resin. The curable adhesive film according to the technical solution of the present invention has no tackiness at room temperature, which enables the curable adhesive film to have the ability to reposition even after being laminated on a substrate, making the curable adhesive film applicable to substrates with irregular shapes. Once initiated by UV radiation, the curable adhesive film is flowable and tacky at elevated temperatures. The cured adhesive has good bonding strength at high temperatures. The curable adhesive film features high bond strength and low odor, and can be used for void filling, especially for side panel bonding of electric vehicle battery modules in the electric vehicle (EV) market.

### TECHNICAL FIELD

The present invention relates to the technical field of structural adhesives, and more specifically, to a curable composition, a curable adhesive film, and an adhesive tape.

### BACKGROUND ART

Structural adhesives are used to bond one or more substrates to another substrate. Typically, an adhesive is coated on a first substrate, a second substrate is then brought into contact with the coated adhesive and laminated together. Heat or ultraviolet light (UV) is applied to the adhesive for a period of time, and the substrates are then bonded together.

At present, electronic products, automotive products, etc. have increasingly higher requirements for structural bonding, and there is a tendency to use adhesive tapes or films instead of bolts. In addition, such types of products also have high requirements on the high temperature resistance of materials. In addition, the trend with current electronic products such as notebooks, handheld mobile terminals, etc. is towards making products that are miniaturized, lighter, and thinner, and have higher production efficiency. This trend calls for the increasing use of polymeric materials (such as plastics, rubber, etc.) for such products. Therefore, it is necessary to use adhesive products with high bonding strength for these materials, to achieve firm bonding with small bonding areas and to achieve low odors from these materials.

Traditionally, single-component or two-component structural glues could meet requirements for bonding components in these products. However, there are many disadvantages in structural glues, such as non-removable or reworkable (that is, reassembly after dismantling) and uncontrollable bonding areas, resulting in unsightly bonding surfaces; moreover, some structural glues contain a large amount of solvents, and require a very long time (low efficiency) or very high temperatures (unable to bond non-heat-resistant plastic materials) to cure. All these aspects have greatly restricted the large-scale use of structural glues in the aforementioned products. However, for the same application, customers require fast manufacturing steps, fast bonding, and initial bonding strength to achieve high productivity.

Pressure-sensitive adhesive tapes are also a product for bonding. Pressure-sensitive adhesive tapes are convenient to use, require only a slight pressure applied to be bonded, and do not require a long time or high temperatures over 160° C. to be cured. The pressure-sensitive adhesive tapes can immediately form bonds following die-cutting, and allow continuous production, thereby reaching extremely high bonding efficiency. However, one critical disadvantage of the pressure-sensitive adhesive tapes is weak bonding strength thereof, which typically does not exceed 1 MPa, rendering the pressure-sensitive adhesive tapes unsuitable for small area bonding.

U.S. Patent application US 2002/182955 A1 (Weglewski) reveals an adhesive tape with a fiber-reinforced single-layer structure. However, the structural adhesive tape requires reinforcement of an adhesive film with specific fibers to reach good shape retention and bonding strength. This makes a manufacturing process significantly more complex and costly. In addition, the production process of this structural adhesive tape further requires hot pressing in vacuum to achieve good bonding effects, which also makes the production process costly and the conditions thereof demanding, making the process difficult to industrialize.

Therefore, it is still desired to develop such adhesive films or adhesive tapes in the art, which have no initial tack at normal temperature, can be cured rapidly, and produce cured products with high structural strength, good high temperature resistance, and no or low odor while solving common adhesive overflow problems.

### SUMMARY

Starting from the technical problem set out above, the object of the present invention is to provide an ultraviolet light (UV)-curable composition, a UV-curable adhesive film, and a UV-curable adhesive tape, which have no initial tack and exhibit a good balance in aspects of high structural strength after curing, high temperature resistance, and no or low odor.

The inventors of the present invention have conducted intensive and detailed research to obtain the present invention.

According to one aspect of the present invention, provided is a curable composition, comprising, based on the total weight thereof as 100 wt %:
15-50 wt % of an ethylene-vinyl acetate copolymer;
10-40 wt % of polyvinyl butyral; and
20-60 wt % of an epoxy resin.

According to another aspect of the present invention, provided is a curable adhesive film, the curable adhesive film comprising the curable composition as described above.

According to another aspect of the present invention, provided is an adhesive tape, the adhesive tape comprising:
a curable adhesive film comprising the curable composition as described above; and
a release film.

Compared with the existing techniques in the art, the present invention has the following advantages: the curable adhesive film according to the technical solution of the present invention has no tackiness at room temperature, which enables the curable adhesive film to have the ability to reposition even after being laminated on a substrate, making the curable adhesive film applicable to substrates with irregular shapes. Once initiated by UV radiation, the curable adhesive film is flowable and tacky at elevated temperatures. The cured adhesive has good bond strength at high temperatures. The curable adhesive film features high bonding strength and low odor, and can be used for void filling, especially for side panel bonding of electric vehicle battery modules in the electric vehicle (EV) market.

### DETAILED DESCRIPTION

It should be appreciated that various other embodiments could be devised and modified by a person skilled in the art in light of the teachings of this description without departing from the scope or spirit of the present disclosure. Therefore, the following particular embodiments are not restrictive in meaning.

Unless otherwise indicated, all numbers used in this description and claims for the dimensions, quantities, and physicochemical properties of features should be construed to be modified by the term “approximately” in all instances. Accordingly, unless indicated to the contrary, the above numerical parameters listed in the description and attached claims are all approximations, which can be properly altered by a person skilled in the art using desired properties sought to be obtained from the teachings disclosed herein. The use of numerical ranges indicated by endpoints includes all numbers within that range and any range within that range, for example, 1 to 5 includes 1, 1.1, 1.3, 1.5, 2, 2.75, 3, 3.80, 4, and 5, etc.

After in-depth research by the inventors of the present invention, it was unexpectedly found that by using a UV-curable composition with specific components and specific contents, a UV-curable adhesive film structure with an excellent performance balance can be provided.

In the structures of the UV-curable composition, the adhesive film, and the adhesive tape provided by the present invention, a UV-induced curable combination of an ethylene-vinyl acetate copolymer/polyvinyl butyral/epoxy resin hybrid system with a specific composition is utilized.

As used herein, the term “curable” means that a referenced composition or adhesive film can be cured by initiating an epoxy resin component in the composition or adhesive film to undergo a chemical reaction under the induction by UV light through a photoinitiator therein. In the present invention, after UV-light irradiation or induction, even after removal of a UV source, epoxy groups can be further initiated to react at room temperature, thus completing the curing process (so-called active polymerization process). In addition, each layer of the adhesive film of the present invention can be produced using a hot-melt method, avoiding the use of solvents, thereby achieving a low-odor effect.

The low-odor UV-curable composition or adhesive film provided by the present invention exhibits characteristics of ordinary thin films at the initial stage of bonding, i.e., has no initial tack, can be arbitrarily moved and fixed before hot pressing, and can be formed through die cutting. After being induced by UV light, the composition or adhesive film can be rapidly cured into an adhesive tape with semi-structural strength to structural strength at room temperature, and can thus be used to bond non-heat-resistant plastics such as PC, PMMA, and ABS. Moreover, the adhesive film provided by the present invention has no odor or low odor, making the adhesive film especially applicable to bonding between internal parts of household appliances and automobiles, between plastic parts, or between plastic parts and metal parts in electronic products such as hand-held mobile terminals. In addition, the UV-induced curable composition or adhesive film according to the present invention has a room-temperature storage period of 24 months or more under dark conditions.

As used herein, the term “structural adhesive” refers to an adhesive with a shear strength greater than 1,000 psi between the adhesive tape and a bonded part (where 1 MPa is approximately 145 psi); the term “structural strength” refers to the shear strength greater than 1,000 psi of a bonded member formed by the adhesive tape and the bonded part; the term “semi-structural strength” refers to the shear strength greater than 100 psi but less than 1,000 psi of the bonded member formed by the adhesive tape and the bonded part.

According to one aspect of the present invention, provided is a curable composition, comprising, based on the total weight thereof as 100 wt %:
15-50 wt % of an ethylene-vinyl acetate copolymer;
10-40 wt % of polyvinyl butyral; and
20-60 wt % of an epoxy resin.

In the UV-curable composition according to the present invention, the ethylene-vinyl acetate copolymer (abbreviated as “EVA”) with the elastomeric performance of rubber is used as a base material. The ethylene-vinyl acetate copolymer used in the present invention may be a non-crosslinked or non-crosslinked linear copolymer or a pre-crosslinked ethylene-vinyl acetate copolymer with a certain degree of crosslinking.

In some preferred embodiments, based on the total weight of the ethylene-vinyl acetate copolymer as 100 wt %, the content of vinyl acetate units in the ethylene-vinyl acetate copolymer is in the range of 70-90 wt %, preferably in the range of 70-80 wt %. This is because the higher the content of vinyl acetate, the higher the Tg of the copolymer, and a cured adhesive film has a higher modulus, so that the obtained adhesive film or adhesive tape has higher shear strength.

Preferably, to achieve the technical effects of the present invention, the Mooney viscosity of the ethylene-vinyl acetate copolymer is in the range of 25-60 MU.

Ethylene-vinyl acetate copolymers useful for the present invention can be prepared according to conventional synthesis methods or can be obtained commercially. Commercially available examples thereof comprise, for example, LEVAPREN 600, LEVAPREN 700, LEVAPREN 800, LEVAPREN 900, LEVAPREN 700 XL, LEVAPREN 800 XL, etc. available from Lanxess Corporation.

Preferably, in the curable composition according to the present invention, polyvinyl butyral with a relatively high glass transition temperature (60-90° C.) is used as a base material, which is beneficial to the high-temperature mechanical properties of the material. The polyvinyl butyral (abbreviated as “PVB”) used in the present invention may be polyvinyl butyral with different degrees of acetalization and different degrees of polymerization. Preferably, the polymerization degree of the polyvinyl butyral is in the range of 300-1,000. Preferably, the acetalization degree of the polyvinyl butyral is greater than 70%, preferably in the range of 72-88%.

Polyvinyl butyral useful for the present invention can be prepared according to conventional synthesis methods or can be obtained commercially. Commercially available examples thereof comprise, for example, B03HX (polymerization degree=300-400; acetalization degree=76-82%), B04HX (polymerization degree=400-500; acetalization degree=76-82%), B05HX (polymerization degree=400-500; acetalization degree=76-82%), B05SY (polymerization degree=300-400; acetalization degree=82-88%), B06HX (polymerization degree=600-700; acetalization degree=76-82%), B08HX (polymerization degree=800-900; acetalization degree=76-82%), B-10TX (polymerization degree=1,700-1,800; acetalization degree=72-88%), B06SY (polymerization degree=600-700; acetalization degree=82-88%), B08SY (polymerization degree=800-900; acetalization degree=82-88%), etc.

In the curable composition according to the present invention, in addition to the ethylene-vinyl acetate copolymer as a base material, an epoxy resin is further used as a base material and a curing component.

Epoxy resins useful for the present invention can be epoxy resins for preparation of adhesives known in the art. Preferably, the epoxy resin is a solid epoxy resin. For example, in some embodiments, epoxy resins used may contain one or more epoxy groups in the molecule, and preferably have an epoxy equivalent in the range of 150-600. Preferably, aromatic epoxy resins such as glycidyl ethers or esters obtained by reaction of polyphenols such as bisphenol A, bisphenol F, bisphenol S, tetramethylbisphenol A, hexahydrobisphenol A, A, diarylbisphenol tetramethylbisphenol F, with, for example, epichlorohydrin, can be used in the present invention. In addition, epoxidized polyolefin and the like are also usable known epoxy resins. Preferably, the epoxy resin is one or more selected from a group consisting of alicyclic epoxy resins and/or epoxidized polyolefins.

Epoxy resins useful for the present invention can be prepared according to conventional synthesis methods or can be obtained commercially. Commercially available examples thereof include, for example, NPES-901 (solid, with an epoxy equivalent of about 450-500) available from South Asia Epoxy (Kunshan) Co., Ltd., and YD 128 (solid, with an epoxy equivalent of about 187) and KD212 (solid, with an epoxy equivalent of 535) available from Kudko Chemical (Korea).

In the present invention, in order to enable the curable composition obtained by the present invention to have a good balance in properties such as no initial tack, impact resistance, and structural strength after curing, especially a good balance of no initial tack and structural strength after curing, the epoxy resin in the composition of the present invention is generally in the range of 20-60 wt %, more preferably in the range of 35-60 wt %, and more preferably in the range of 40-50 wt %.

The curable composition of the present invention may optionally comprise a toughening agent. The toughening agent plays the role of toughening and improving impact resistance in the cured curable composition. Preferably, the toughening agent is a toughening resin with a core-shell structure. Preferably, based on the total weight of the curable composition as 100 wt %, the curable composition comprises 5-30 wt % of the toughening agent.

Toughening resins with a core-shell structure useful for the present invention are commercially available, and examples thereof are, for example, MX 150, MX 154, and MX 257, etc. available from Kaneka Chemical, Japan.

The curable composition according to the present invention may optionally comprise a silane coupling agent. The silane coupling agent can increase the degree of crosslinking of the curable composition after curing, thereby improving the mechanical properties thereof. Preferably, based on the total weight of the curable composition as 100 wt %, the curable composition comprises 0.3-5 wt % of the silane coupling agent. Silane coupling agents useful for the present invention are commercially available, and examples thereof are, for example, silane coupling agent KH-560 available from Sinopharm Chemical Reagent Group Co., Ltd.

The curable composition according to the present invention may optionally comprise a chain transfer agent. The chain transfer agent acts as a chain transfer agent when epoxy groups in the epoxy resin react by a cationic mechanism.

Preferably, the chain transfer agent is a hydroxyl-containing compound. Hydroxy-containing compounds useful for the present invention include ether or ester derivatives of such hydroxy-containing compounds. In some preferred embodiments, the hydroxy-containing compound may be a polyol compound. Examples of polyol that may be used include, but are not limited to polyether polyols, e.g., polyether diols; polyester polyols, e.g., polyester diols; and bisphenol A polyols, and the like. One of, or a mixture of more than one of, the above polyols may be used. Preferably, the chain transfer agent contains a hydroxyl-containing compound selected from a group consisting of polyols and esters or ethers of polyols.

Preferably, based on the total weight of the curable composition as 100 wt %, the curable composition comprises 0.3-8 wt % of the chain transfer agent.

Hydroxy-containing compounds useful for the present invention are commercially available, and examples thereof include, for example, TONE 0230 Polyol, VORANOL 230-238, and VORANOL 2070 available from Dow Chemical (U.S.); and Dianol 285 available from J4T Seppic Company (France), etc. In some embodiments, Voranol 2070, which is a polyether diol with a molecular weight of 700, available from U.S. Dow Chemical is used.

In the present invention, the content of the hydroxyl-containing compound in the curable composition is in the range of 0.3-8.0 wt %, preferably 1.0-6.0 wt %, more preferably 2.0-4.0 wt %. The inventors of the present invention have found that, only when the hydroxyl-containing compounds are present in the curable composition of the present invention within the above content ranges respectively, can the obtained adhesive film or adhesive tape have the above balanced performance. Moreover, if the content of the polyol compound is overly low, the curing speed of the UV-induced pressure-sensitive adhesive tape obtained is slow after induction by UV light and the cured adhesive tape will be brittle, whereas if the content of the polyol is overly high, the cured adhesive tape will be overly soft, which affects the shear strength.

The curable composition according to the present invention may optionally comprise a photoinitiator. Although the photoinitiator is used in a small amount in the curable composition, the photoinitiator has great effects on the curing speed and storage stability of the curable composition.

The photoinitiators that can be used for the present invention may be at least one selected from cationic photoinitiators. Useful cationic photoinitiators include, but are not limited to, diazonium salts, iodonium salts, sulfonium salts, antimonates, iron arene salts, etc. Specific examples thereof include diaryliodonium salts, diarylsulfonium salts, alkylsulfonium salts, iron arene salts, sulfonyloxyketones, and diarylsiloxyethers. In some embodiments, diaryl sulfonium hexafluorophosphate or hexafluoroantimonate salts are used. Such photoinitiators are commercially available, and an example thereof is for example DOUBLECURE 1176 available from Double Bond Chemical Company, Taiwan, China.

In the present invention, the content of the photoinitiator such as a cationic photoinitiator in the curable composition ranges from 0.5 wt % to 5 wt %, preferably from 0.75 wt % to 2.5 wt %. In general, as the content of the photoinitiator such as a cationic photoinitiator increases, the curing speed of the curable composition increases. However, if the content is overly high, the curing speed will be overly high, and curing can occur even under sunlight or lamp light (including a small amount of UV light), which will cause damage to some performance of the curable adhesive film or adhesive tape, such as poor storage stability at room temperature; if the amount of the cationic photoinitiator is overly low, requirements for UV radiation energy are high during curing and the curing speed is low, which will also cause damage to some performance of the curable adhesive film or adhesive tape.

Additionally, as known by those skilled in the art, according to requirements in practical applications, the curable composition of the present invention may further contain other ingredients or additive aids well known in the art. There is no special limitation to the types and contents of these other components, provided that required performance of the curable composition according to the present invention is not affected. In a preferred embodiment, the curable composition according to the present invention may comprise one or more selected from a group consisting of electrically conductive agents, thermally conductive agents, flame retardants, and fillers. In a further preferred embodiment, the electrically conductive agent can be, for example, conductive particles or fibers (for example, based on the total weight of the curable composition as 100 wt %, 2-45 wt %), the thermally conductive agent can be thermally conductive particles or fibers (for example, based on the total weight of the curable composition as 100 wt %, 2-45 wt %), the flame retardant can be, for example, zinc borate (for example, based on the total weight of the curable composition as 100% wt %, 2-30 wt %); the filler can be fumed silica (for example, based on the total weight of the curable composition as 100 wt %, 0.5-8 wt %).

The curable composition according to the present invention may or may not contain a solvent. In a preferred embodiment, the curable composition according to the present invention do not contain solvents, especially organic solvents. In such a case, the curable composition according to the present invention may be in the form of, for example, a powder or a particle mixture. Such a curable composition can be prepared by, for example, simply mixing components in a mixing container or machine. Avoiding the use of solvents can reduce the odor of the curable composition.

According to another aspect of the present invention, provided is a curable adhesive film comprising the curable composition as described above. The curable adhesive film can be formed by hot extrusion or melt extrusion of the curable composition according to the present invention. Preferably, the thickness of the curable adhesive film is in the range of 0.05-0.5 mm.

According to a further aspect of the present invention, provided is an adhesive tape. The adhesive tape comprises:
a curable adhesive film comprising the curable composition as described above; and
a release film.

The adhesive tape can be formed by hot extrusion or melt extrusion of the curable composition according to the present invention onto a flexible or non-flexible substrate, including a release film or paper. Optionally, the adhesive tape can be formed by hot extrusion or melt extrusion of the curable composition according to the present invention into a sheet and attaching the sheet to a flexible or non-flexible substrate, including a release film or release paper. As the release film or release paper, release films or release papers known in the prior art can be used, e.g., PET release films, glass papers, laminated papers, and polypropylene films. Preferably, the release film or release paper is attached to two opposite sides of the curable adhesive film. Preferably, the release film or release paper is attached to one side of the curable adhesive film, and a substrate layer is attached to an opposite side. Optionally, the substrate layer is selected from a group consisting of polymeric films, woven or nonwoven fabric layers, metal foils, foam layers, and combinations thereof.

The curable adhesive film/adhesive tape provided by the present invention exhibits the characteristics of ordinary hot-stick thin films at the initial stage of bonding, that is, no initial tack, and can be bonded to a bonded object under a slight pressure applied at a high temperature, and can be formed through die-cutting. In addition, after being induced by UV light, the adhesive film/adhesive tape can be cured into an adhesive tape with semi-structural strength to structural strength at room temperature, and can thus be used to bond non-heat-resistant plastics such as PC, PMMA, and ABS. Moreover, the adhesive film/adhesive tape according to the present invention has no odor or low odor, making the adhesive film/adhesive tape especially suitable for bonding between internal parts of household appliances and automobiles, between plastic parts, or between plastic parts and metal parts in electronic products such as hand-held mobile terminals.

Various exemplary embodiments of the present invention are further described by a list of embodiments below, which should not be construed as unduly limiting the present invention:

Embodiment 1 is a curable composition, wherein the curable composition comprises, based on the total weight thereof as 100 wt %:
15-50 wt % of an ethylene-vinyl acetate copolymer;
10-40 wt % of polyvinyl butyral; and
20-60 wt % of an epoxy resin.

Embodiment 2 is the curable composition according to Embodiment 1, wherein the ethylene-vinyl acetate copolymer comprises 70-90 wt % of vinyl acetate units based on the total weight of the ethylene-vinyl acetate copolymer as 100 wt %.

Embodiment 3 is the curable composition according to Embodiment 1, wherein the Mooney viscosity of the ethylene-vinyl acetate copolymer is in the range of 25-60 MU.

Embodiment 4 is the curable composition according to Embodiment 1, wherein the polymerization degree of the polyvinyl butyral is in the range of 300-1,000.

Embodiment 5 is the curable composition according to Embodiment 1, wherein the acetalization degree of the polyvinyl butyral is greater than 70%.

Embodiment 6 is the curable composition according to Embodiment 1, wherein the epoxy resin is a solid epoxy resin.

Embodiment 7 is the curable composition according to Embodiment 1, wherein the epoxy resin is one or more selected from the group consisting of cycloaliphatic epoxy resins or epoxidized polyolefins.

Embodiment 8 is the curable composition according to Embodiment 5, wherein the epoxy equivalent weight of the epoxy resin is in the range of 150-600.

Embodiment 9 is the curable composition according to Embodiment 1, wherein the curable composition further comprises 5-30 wt % of a toughening agent.

Embodiment 10 is the curable composition according to Embodiment 9, wherein the toughening agent is a toughening resin with a core-shell structure.

Embodiment 11 is the curable composition according to Embodiment 1, wherein the curable composition further comprises 0.3-5 wt % of a silane coupling agent.

Embodiment 12 is the curable composition according to Embodiment 1, wherein the curable composition further comprises 0.3-8 wt % of a chain transfer agent.

Embodiment 13 is the curable composition according to embodiment 12, wherein the chain transfer agent is a hydroxyl-containing compound.

Embodiment 14 is the curable composition according to embodiment 13, wherein the hydroxyl-containing compound is selected from the group consisting of polyols and esters or ethers of polyols.

Embodiment 15 is the curable composition according to Embodiment 1, wherein the curable composition further comprises 0.5-5 wt % of a photoinitiator.

Embodiment 16 is the curable composition according to Embodiment 15, wherein the photoinitiator is a cationic photoinitiator.

Embodiment 17 is the curable composition according to Embodiment 16, wherein the cationic photoinitiator is one or more selected from a group consisting of diazonium salts, iodonium salts, sulfonium salts, antimonium salts, and iron arene salts.

Embodiment 18 is the curable composition according to Embodiment 1, wherein the curable composition further comprises one or more selected from the group consisting of electrically conductive agents, thermally conductive agents, flame retardants, and fillers.

Embodiment 19 is the curable composition according to Embodiment 1, wherein the curable composition is solvent-free.

Embodiment 20 is a curable adhesive film, wherein the curable adhesive film comprises the curable composition according to any one of Embodiments 1 to 19.

Embodiment 21 is the curable adhesive film according to Embodiment 20, wherein the curable adhesive film has a thickness in the range of 0.05-0.5 mm.

Embodiment 22 is an adhesive tape, wherein the adhesive tape comprises:
a curable adhesive film comprising the curable composition according to any one of Embodiments 1 to 19; and
a release film.

Embodiment 23 is the adhesive tape according to Embodiment 22, wherein the release film is attached to two opposite sides of the curable adhesive film.

Embodiment 24 is the tape according to Embodiment 22, wherein the release film is attached to one side of the curable adhesive film, and a substrate layer is attached to an opposite side.

Embodiment 25 is the adhesive tape according to Embodiment 24, wherein the substrate layer is selected from the group consisting of polymeric films, woven or nonwoven fabric layers, metal foils, foam layers, and combinations thereof.

The present invention will be described in more detail below with reference to examples. It should be pointed out that these descriptions and examples are for the purpose of facilitating the understanding of the present invention, rather than limiting the present invention. The scope of protection of the present invention is subject to the appended claims.

### EXAMPLES

The present invention is further described in detail below with reference to examples and comparative examples. It should be understood that the present invention is not limited to the following examples.

In the following examples and comparative examples, unless otherwise specified, “portion” all refers to “portion by weight,” “%” all refers to “wt %”, and “g” all refers to the weight unit “gram.” In the present invention, unless otherwise indicated, the used reagents are all commercially available products and are used directly without being further purified.

TABLE 1
List of raw materials

| Product Name | Description | Supplier |
|---|---|---|
| LEVAPREN 600 | Un-crosslinked ethylene-vinyl acetate copolymer | Lanxess Chemical, |
| | (with a content of vinyl acetate units of 60 wt %, and | Germany |
| | a Mooney viscosity of 27) | |
| LEVAPREN 700 | Un-crosslinked ethylene-vinyl acetate copolymer | Lanxess Chemical, |
| | (with a content of vinyl acetate units of 70 wt %, and | Germany |
| | a Mooney viscosity of 27) | |
| LEVAPREN 800 | Un-crosslinked ethylene-vinyl acetate copolymer | Lanxess Chemical, |
| | (with a content of vinyl acetate units of 80 wt %, and | Germany |
| | a Mooney viscosity of 28) | |
| LEVAPREN 900 | Un-crosslinked ethylene-vinyl acetate copolymer | Lanxess Chemical, |
| | (with a content of vinyl acetate units of 90 wt %, and | Germany |
| | a Mooney viscosity of 38) | |
| PVB BO5SY | Polyvinyl butyral (with a polymerization degree of | Changchun Petrochemical |
| | 300-400, and an acetalization degree of 82-88%) | Co., Ltd. |
| PVB BO8SY | Polyvinyl butyral (with a polymerization degree of | Changchun Petrochemical |
| | 800-900, and an acetalization degree of 82-88%) | Co., Ltd. |
| Mowital B 14 S | Polyvinyl butyral resin (with a polymerization | Kuraray |
| | degree of 200-300, and an acetalization degree of | |
| | 74-81%) | |
| Mowital B 30 T | Polyvinyl butyral resin (with a polymerization | Kuraray |
| | degree of 300-400, and an acetalization degree of | |
| | 65-72%) | |
| Mowital B 60 H | Polyvinyl butyral resin (with a polymerization | Kuraray |
| | degree of 1,200-1,300, and an acetalization degree | |
| | of 75-81%) | |
| Epoxy 901 | Bisphenol A type epoxy resin (solid, epoxy | South Asia Epoxy Co., Ltd. |
| | equivalent weight: about 450-500) | |
| Epon 828 | Bisphenol A epoxy resin (liquid, epoxy equivalent: | Korea Kudko Chemical |
| | 187) | Co., Ltd. |
| MX 257 | Toughening resin with a core-shell structure | Kaneka Chemical, Japan |
| KH-560 | Silane coupling agent | Sinopharm Chemical |
| | | Reagent Group Co., Ltd. |
| VORANOL 2070 | Polyether polyol | Dow Chemical Company, |
| | | U.S. |
| DOUBLECURE | Photoinitiator | Double Bond Chemical, |
| 1176 | | Taiwan, China |

### Test Methods

Each of curable adhesive films prepared in the following examples and comparative examples was tested with respect to odor and dynamic shear strength according to specific methods described below.

### Odor Detection

The odor of each curable film prepared in the following examples and comparative examples is evaluated by human smelling, and the curable film is determined to be qualified if the curable film does not have any pungent odor (i.e., no odor or low odor).

### Dynamic Shear Strength

Each curable adhesive film prepared in the following examples and comparative examples is cut into a size of 25.4 mm×25.4 mm, and a release film is torn off to obtain an adhesive strip. One adhesive surface of the adhesive strip is adhered to a standard test steel plate. The adhesive surface of the test steel plate is put upwards, and is irradiated in a UV radiation amount controlled at 1 J/cm² (8 min) for 5 minutes with a UV-LED ultraviolet lamp (Model KT403) from Yuntong Company, with curing energy of 3,000 mJ/cm². Then, the irradiated adhesive surface of the steel plate is combined with another standard test steel plate, and hot pressed at 160° C. for 2 minutes using a hot press (pressure 10 Kg). The specific procedure is carried out in accordance with ASTM D3330.

Then, according to the method described in FINAT FTM 2 (FINAT Technical Manual Test Method, 8th Edition) (FTM2 is equivalent to a second test method), the dynamic shear strength (MPa) of the samples is measured at 25° C. (i.e., room temperature) and 60° C. (i.e., a typical use temperature of new energy vehicle power batteries) respectively using a tensile testing machine (Instron 3300) produced by Instron Corporation, US. Data of five dynamic shear strength tests is recorded and an average value thereof is used as the dynamic shear strength (unit: MPa). The test results are shown in Tables 2 and 3 below.

When the dynamic shear strength of a sample at 25° C. (i.e., room temperature) is greater than or equal to 8 MPa, the 25° C. bonding strength of the sample is considered excellent; when the dynamic shear strength of the sample at 25° C. (i.e., room temperature) is greater than or equal to 7 MPa and less than 8 MPa, the 25° C. bonding strength of the sample is considered qualified.

In addition, when the dynamic shear strength of the sample at 60° C. is greater than or equal to 4 MPa (i.e., a typical operating temperature of new energy vehicle power batteries), the 60° C. adhesive strength of the sample is considered excellent; when the dynamic shear strength of the sample at 60° C. is greater than or equal to 3 MPa and less than 4 MPa, the 60° C. bonding strength of the sample is considered qualified.

### Example 1 (E1)

16.5 g of an ethylene-vinyl acetate copolymer LEVAPREN 800, 24 g of polyvinyl butyral PVB BO5SY, 41 g of bisphenol type A epoxy resin Epoxy 901, 12 g of a core-shell structured toughening resin MX 257, 0.5 g of a silane coupling agent KH-560, 4 g of a polyether polyol VORANOL 2070, and 2 g of a photoinitiator DOUBLECURE 1176 were uniformly mixed to obtain a blend. The blend was added to a CPM-40 twin-screw extruder produced by CPM Corporation, and fully mixed and melt-extruded onto a Baoyan PCK release film at 155° C. to obtain a stack of an adhesive film and a release film. The thickness of the adhesive film is 0.2 mm.

### Examples 2-9 (E2-E9) and Comparative Examples 1-11 (CE1-CE11)

Adhesive tape samples 2-9 and comparative adhesive tape samples 1-11 were prepared in a similar manner to that in Example 1, except that the specific types and contents thereof of various raw materials were changed as shown in Tables 2 and 3 below.

The adhesive tape samples 2-9 and the comparative adhesive tape samples 1-11 were then separately tested according to the test methods for odor and dynamic shear strength as detailed above. Specific test results of Examples 1-9 (E1-E9) are shown in Table 2 below, and specific test results of Comparative Examples 1-11 (CE1-CE11) are shown in Table 3 below.

TABLE 2
Proportions of components and performance test results of adhesive tape samples 1-9 prepared in Examples 1-9 (E1-E9)

| | E1 | E2 | E3 | E4 | E5 | E6 | E7 | E8 | E9 |
|---|---|---|---|---|---|---|---|---|---|
| LEVAPREN 700 | | | | | 21.5 | | | | |
| LEVAPREN 800 | 16.5 | 21.5 | 48.5 | 21.5 | | | 29.5 | 31.5 | 17.5 |
| LEVAPREN 900 | | | | | | 21.5 | | | |
| PVB BO5SY | 24 | 19 | 10 | | 19 | 19 | 11 | 29 | 12 |
| PVB BO8SY | | | | 20 | | | | | |
| Epoxy 901 | 41 | 41 | 23 | 41 | 41 | 41 | 41 | 21 | 58 |
| MX 257 | 12 | 12 | 12 | 12 | 12 | 12 | 12 | 12 | 6 |
| KH-560 | 0.5 | 0.5 | 0.5 | 0.5 | 0.5 | 0.5 | 0.5 | 0.5 | 0.5 |
| VORANOL 2070 | 4 | 4 | 4 | 4 | 4 | 4 | 4 | 4 | 4 |
| Doublecure 1176 | 2 | 2 | 2 | 2 | 2 | 2 | 2 | 2 | 2 |
| Total | 100 | 100 | 100 | 101 | 100 | 100 | 100 | 100 | 100 |

Performance test results

| | | | | | | | | | |
|---|---|---|---|---|---|---|---|---|---|
| Odor | None | None | None | None | None | None | None | None | None |
| Dynamic shear | 8.4 | 10.2 | 8.1 | 9.4 | 8.5 | 9.2 | 8.4 | 9.7 | 8.1 |
| strength @25° C. (MPa) | | | | | | | | | |
| Dynamic shear | 4.1 | 5.4 | 4 | 4.9 | 4.1 | 5.6 | 4.2 | 4.7 | 4.1 |
| strength @60° C. (MPa) | | | | | | | | | |
| Note | No initial | No initial | No initial | No initial | No initial | No initial | No initial | No initial | No initial |
| | tack | tack | tack | tack | tack | tack | tack | tack | tack |

TABLE 3
Proportions of components and performance test results of comparative adhesive
tape samples 1-11 prepared in Comparative Examples 1-11 (C1-C11)

| | C1 | C2 | C3 | C4 | C5 | C6 | C7 | C8 | C9 | C10 | C11 |
|---|---|---|---|---|---|---|---|---|---|---|---|
| LEVAPREN 600 | | | | | | | 21.5 | | | | |
| LEVAPREN 700 | | | | | | | | | | | |
| LEVAPREN 800 | 13.5 | 51.5 | 31.5 | 19.5 | 33.5 | 16.5 | | 21.5 | 21.5 | 21.5 | 21.5 |
| LEVAPREN 900 | | | | | | | | | | | |
| PVB BO5SY | 27 | 10 | 9 | 41 | 29 | 10 | 19 | 19 | | | |
| PVB BO8SY | | | | | | | | | | | |
| Mowital B 14 S | | | | | | | | | 19 | | |
| Mowital B 30 T | | | | | | | | | | 19 | |
| Mowital B 60 H | | | | | | | | | | | 19 |
| Epoxy 901 | 41 | 20 | 41 | 21 | 19 | 61 | 41 | | 41 | 41 | 41 |
| Epon 828 | | | | | | | | 41 | | | |
| MX 257 | 12 | 12 | 12 | 12 | 12 | 6 | 12 | 12 | 12 | 12 | 12 |
| KH-560 | 0.5 | 0.5 | 0.5 | 0.5 | 0.5 | 0.5 | 0.5 | 0.5 | 0.5 | 0.5 | 0.5 |
| VORANOL 2070 | 4 | 4 | 4 | 4 | 4 | 4 | 4 | 4 | 4 | 4 | 4 |
| Doublecure 1176 | 2 | 2 | 2 | 2 | 2 | 2 | 2 | 2 | 2 | 2 | 2 |
| Total | 100 | 100 | 100 | 100 | 100 | 100 | 100 | 100 | 100 | 100 | 100 |

Performance test results

| | | | | | | | | | | | |
|---|---|---|---|---|---|---|---|---|---|---|---|
| Odor | None | None | None | None | None | None | None | None | None | None | None |
| Dynamic shear | 6.2 | 7.6 | 8.2 | 6.5 | 7.6 | 6.1 | 7.1 | 9.7 | 6.2 | 7.3 | |
| strength @25° C. | | | | | | | | | | | |
| (MPa) | | | | | | | | | | | |
| Dynamic shear | 3.7 | 3.5 | 3.7 | 4.6 | 3.5 | 3 | 2.7 | 4.7 | 3.2 | 3.8 | |
| strength @60° C. | | | | | | | | | | | |
| (MPa) | | | | | | | | | | | |
| Note | No initial | No initial | No initial | No initial | No initial | Difficult | Less | Initial | Initial | No initial | Unable to be |
| | tack | tack | tack | tack | tack | to form | compatible | tack | tack | tack | coated |

Firstly, for the adhesive films/tapes prepared by a hot melt extrusion method in the above examples and comparative example, all of the adhesive films/tapes are odorless or low-odor qualified products according to odor detection, which means that these adhesive film/adhesive tape products can be applied to bonding between internal parts of household electric appliances and automobiles, and between plastic parts and plastic parts or between plastic parts and metal parts in electronic products such as hand-held mobile terminals.

Secondly, it can be seen from the results shown in Table 2 above that the adhesive films/tapes prepared in Examples 1-9 having the curable components and the specific contents thereof required by the present invention have a good balance in aspects of initial tack, bonding strength, high temperature performance, and coatability, especially meeting the technical standard requirements for both dynamic shear strength at 25° C. and dynamic shear strength at 60° C. In contrast, the adhesive films/adhesive tapes prepared in Comparative Examples 1-9 formed using curable compositions that do not meet the specific composition required by the present invention cannot achieve a good balance of the above properties.

More specifically, in Example 2, the ethylene-vinyl acetate copolymer having a vinyl acetate unit content of 80% and polyvinyl butyral PVB BO5SY were used. Because the content of vinyl acetate units was appropriate, the acetalization degree and polymerization degree of the polyvinyl butyral PVB BO5SY were the most appropriate. Furthermore, the contents of the epoxy resin and the toughening resins were also appropriate, so that the adhesive film could achieve the best comprehensive performance.

In Example 4, better adhesive performance could also be achieved using polyvinyl butyral PVB BO8SY with a higher molecular weight.

In Examples 5 and 6, the ethylene-vinyl acetate copolymers with a vinyl acetate unit content of 70% and 90% were used, which could also achieve better adhesive performance.

In Comparative Example 1 and Comparative Example 2, the content of the ethylene-vinyl acetate copolymer was overly low or overly high. The overly low ethylene-vinyl acetate copolymer content made it difficult for the adhesive film to maintain a shape, difficult to die-cut, and unsuitable for use, and the adhesion was overly weak; the overly high ethylene-vinyl acetate copolymer content caused the corresponding content of the polyvinyl butyral and content of the epoxy resin to decrease, resulting in low modulus of the cured adhesive film and worse high temperature resistance.

In Comparative Example 3 and Comparative Example 4, the content of the polyvinyl butyral was overly low or overly high. The overly low content of the polyvinyl butyral led to a low overall glass transition temperature, a lower modulus, and worse high temperature resistance of the adhesive film after curing; the overly high polyvinyl butyral content caused the corresponding content of the ethylene-vinyl acetate copolymer and content of the epoxy resin to decrease, making the content of high glass transition temperature components in the system overly high, resulting in increased difficulty in hot-melt processing, decreased dynamic shear strength, and increased hot-stick temperatures.

In Comparative Example 5 and Comparative Example 6, the content of the epoxy resin NPES 901 was overly low or overly high. The overly low epoxy resin content led to an overly low content of curable components in the adhesive film, a lower modulus of the adhesive film after curing, and worse high temperature resistance; the overly high epoxy resin content caused the corresponding content of the ethylene-vinyl acetate copolymer and content of the epoxy resin to decrease, and film-forming components of the system to be reduced, making the adhesive film difficult to form and difficult to die-cut and hot-press, and the toughness, impact resistance, and adhesion of the adhesive film became worse after curing.

In Comparative Example 7, the ethylene-vinyl acetate copolymer having a vinyl acetate unit content of 60% was used. The lower content of vinyl acetate units led to poor compatibility between the ethylene-vinyl acetate copolymer and the epoxy resin, and the prepared adhesive film had no good performance and low dynamic shear strength.

In Comparative Example 8, the liquid epoxy resin YD128 was used instead of the solid epoxy resin NPES 901. Since YD128 is liquid, the adhesive film had high tackiness after coating, failing to meet the requirement of no tackiness, and the adhesive film could not arbitrarily displace.

In Comparative Example 9, the polyvinyl butyral with a lower polymerization degree was used. The lower polymerization degree caused the uncured adhesive film to be viscous, and the cured adhesive film had a low modulus and low dynamic shear viscosity at high temperatures.

In Comparative Example 10, the polyvinyl butyral with a lower acetalization degree was used. The lower acetalization degree resulted in a low modulus of the cured adhesive film and a lower dynamic shear viscosity at high temperatures.

In Comparative Example 11, the polyvinyl butyral Mowital B 60 H having a relatively large molecular weight was used. The polyvinyl butyral with a larger molecular weight had higher requirements on the temperature of hot-melt extrusion, and was not easy to achieve hot-melt coating.

Although specific embodiments have been shown and described in the present invention, a person skilled in the art would understand that various alternative and/or equivalent embodiments may be used to substitute the specific embodiments shown and described without departing from the scope of the present invention. The present application is intended to encompass any adaptations or variations of the specific embodiments discussed in the present invention. Accordingly, the present invention is subject only to the claims and equivalents thereof.

A person skilled in the art should appreciate that various modifications and changes could be made without departing from the scope of the present invention. Such modifications and changes are intended to fall within the scope of the present invention as defined by the appended claims.

1. A curable composition, the curable composition comprising, based on the total weight thereof as 100 wt %:
15-50 wt % of an ethylene-vinyl acetate copolymer;
10-40 wt % of polyvinyl butyral;
20-60 wt % of an epoxy resin, wherein the epoxy resin is a solid epoxy resin; and
0.5-5 wt % of a photoinitiator.

2. The curable composition according to claim 1, wherein the ethylene-vinyl acetate copolymer comprises 70-90 wt % of vinyl acetate units based on the total weight of the ethylene-vinyl acetate copolymer as 100 wt %.

3. The curable composition according to claim 1, wherein the Mooney viscosity of the ethylene-vinyl acetate copolymer is in the range of 25-60 MU.

4. The curable composition according to claim 1, wherein the polymerization degree of the polyvinyl butyral is in the range of 300-1,000.

5. The curable composition according to claim 1, wherein the acetalization degree of the polyvinyl butyral is greater than 70%.

6. (canceled)

7. The curable composition according to claim 1, wherein the epoxy resin is one or more selected from a group consisting of alicyclic epoxy resins or epoxidized polyolefins.

8. The curable composition according to claim 1, wherein the epoxy equivalent of the epoxy resin is in the range of 150-600.

9. The curable composition according to claim 1, wherein the curable composition further comprises 5-30 wt % of a toughening agent.

10. The curable composition according to claim 9, wherein the toughening agent is a toughening resin with a core-shell structure.

11. The curable composition according to claim 1, wherein the curable composition further comprises 0.3-5 wt % of a silane coupling agent.

12. The curable composition according to claim 1, wherein the curable composition further comprises 0.3-8 wt % of a chain transfer agent.

13. The curable composition according to claim 12, wherein the chain transfer agent is a hydroxyl-containing compound.

14. The curable composition according to claim 13, wherein the hydroxyl-containing compound is selected from a group consisting of polyols and esters or ethers of polyols.

15. (canceled)

16. The curable composition according to claim 1, wherein the photoinitiator is a cationic photoinitiator.

17. The curable composition according to claim 16, wherein the cationic photoinitiator is one or more selected from a group consisting of diazonium salts, iodonium salts, sulfonium salts, antimonium salts, and iron arene salts.

18. The curable composition according to claim 1, wherein the curable composition further comprises one or more selected from a group consisting of electrically conductive agents, thermally conductive agents, flame retardants, and fillers.

19. The curable composition according to claim 1, wherein the curable composition is solvent-free.

20. A curable adhesive film, comprising the curable composition according to claim 1.

21. The curable adhesive film according to claim 20, wherein the thickness of the curable adhesive film is in the range of 0.05-0.5 mm.

22. An adhesive tape, comprising:
a curable adhesive film comprising the curable composition according to claim 1; and
a release film.

23. The adhesive tape according to claim 22, wherein the release film is attached to two opposite sides of the curable adhesive film.

24. The adhesive tape according to claim 22, wherein the release film is attached to one side of the curable adhesive film, and a substrate layer is attached to an opposite side.

25. The adhesive tape according to claim 24, wherein the substrate layer is selected from a group consisting of polymeric films, woven or nonwoven fabric layers, metal foils, foam layers, and combinations thereof.
